(19) United States
(12) Patent Application Publication
(10) Pub. No.: US 2011/0083007 A1
(43) Pub. Date: Apr. 7, 2011

(54) RECORDING DEVICE AND METHOD FOR ACTIVATING THE SAME

(76) Inventors: Tsutomu Mori, Osaka (JP); Masafumi Nosaka, Osaka (JP); Takeshi Hasegawa, Osaka (JP); Takeshi Umemoto, Osaka (JP)

(21) Appl. No.: 12/997,348

(22) PCT Filed: Jun. 8, 2009
(86) PCT No.: PCT/JP2009/002568

§ 371 Date: Dec. 10, 2010

(30) Foreign Application Priority Data
Jun. 11, 2008 (JP) 2008--152598

(51) Int. Cl. G06F 9/24

(52) U.S. Cl. 713/2

(57) ABSTRACT

A recording device (101) can record data to a recording medium (164) that executes initialization operation when the recording medium (164) receives an initialization command, and the recording device (101) includes controller (160) for controlling operation of the recording device (101) and storage unit (190) for storing an operating system (5) which is executed by the controller (160) after a start-up of the recording device (101) is completed, and provides a predetermined function. The controller (160) performs start-up control so that the controller provides an instruction for initializing the recording medium when the recording device (101) is powered on, and, in parallel with the initialization of the recording medium (164), the controller (160) executes initialization of the operating system (5).

### TECHNICAL FIELD

The present invention relates to a recording device for recording various kinds of information to a recording medium including a controller.

### BACKGROUND ART

Recently, recording devices such as a digital camera and a digital video camera capable of recording captured images to a recording medium such as a memory card are widely prevalent. Such recording device is required to reduce a time from when the recording device is powered on to when the recording device becomes ready to record a video (which may be hereinafter referred to as “start-up time”) in order to avoid failing to shoot a scene which a user wants to shoot.

In particular, in order to reduce battery consumption, a digital video camera is often powered off when the digital video camera is not capturing any video. Therefore, reduction of the start-up time is a crucial problem to be solved.

For example, Patent Document 1 discloses a technique with which the start-up time can be reduced. FIG. 5 is a diagram illustrating a data area of a ROM storing programs executed during start-up of a recording device in Patent Document 1. As shown in FIG. 5, in Patent Document 1, the programs processed during start-up of the recording device is divided into a first block 202 and a second block 203 other than the first block 202. The first block 202 is a program relating to a start-up processing of the recording device, and includes an OS (Operating System) and a recording medium control (recording medium control (initialization processing)) program. The second block 203 includes other programs and data. When the recording device is powered on, a boot processing program 201 is executed first. Then, the program included in the first block 202 is loaded from a nonvolatile memory. When the loading of the program is completed, the programs and the like included in the second block 203 are loaded. When the loading of the first block 202 is completed, the recording medium control program included in the first block 202 is executed, and the initialization processing of the recording medium is performed in parallel with the loading of the second block 203.

Therefore, in this case, the start-up time can be reduced compared with a case where, for example, the plurality of programs and data are continuously loaded without dividing them and upon completion of the loading, the initialization processing of the recording medium is subsequently performed.

### Prior Art Document

### Patent Document

Patent: Document 1: JP-A-2008-65641

### DISCLOSURE OF INVENTION

### Problems to be Solved by the Invention

By the way, the capacities of recording media such as memory cards are becoming larger year by year. Therefore, it takes a longer time to perform an initialization processing of a recording medium; than in the past.

On the ether hand, the sizes of programs relating to start-up processing are also becoming larger. In particular, the size of OS is becoming larger. Therefore, it takes a longer time to load an OS from a nonvolatile memory and to perform OS initialization processing (including OS boot processing) than in the past.

In Patent Document 1, it is generally considered that the initialization of the recording medium is started after the OS and the recording medium control program are loaded, afterwards the OS initialization processing (including boot processing) is further completed. In other words, the initialization of the recording medium is actually started after the loading and initialization processing of the OS, of which processing time is becoming longer. Therefore, the recording device hakes a longer start-up time from when the recording device is powered on to when the recording device becomes ready to record a video. As a result, a user is more likely to fail to shoot a scene which he or she wants to shoot.

The present invention is made in view of die above. problems, and it is an object of the present invention to provide a recording device that can start with a short start-up time from when the recording device is powered on to when the recording device becomes ready to record a video.

### Means for Solving the Problems

According to an aspect of the present invention, there is provided a recording device capable of recording data to a recording medium that executes initialization operation when the recording medium receives an initialization command, the recording device includes a controller operable to control operation of the recording device, and a storage unit operable to store an operating system which is executed by the controller after a start-up of the recording device is completed, and provides a predetermined function. The controller performs start-up control so that the controller provides an instruction for initializing the recording medium when the recording device is powered on, and in parallel with the initialization of the recording medium, the controller executes initialization of the operating system.

According to another aspect of the present invention, there is provided a method for activating a recording device capable of recording data to a recording medium that executes initialization operation when the recording medium receives an initialization command, the method includes, when the recording device is powered on, initializing, by the recording device, an operating system which provides a predetermined function in the recording device when a start-up of the recording device is completed, in parallel with initialization of the recording medium.

### Advantages of the Invention

In the recording device according to the present invention, the start-up control is performed so that the instruction for initializing the recording medium is given when the recording device is powered on, arid in parallel with the Initialization of the recording medium, the initialization of the operating system is executed. Accordingly, the initialization processing of the recording medium is started without waiting for the completion of the initialization processing of the operating system which takes a lot of time to be completed. Therefore, the initialization processing of the memory medium, which is likely to take a longer processing time when the capacity of the memory medium is large, can be completed in a shorter time compared with a case where the initialization processing of the memory medium is executed after the initialization processing of the operating system is completed. In other words, the time from when the recording device is powered on to when the recording device becomes ready to record a video can be reduced.

### BRIEF DESCRIPTION OF DRAWINGS

FIG. 1 is a block diagram illustrating a configuration of a video camera according to an embodiment of a recording device of the. present invention.

FIG. 2 is a figure illustrating an overview of a ROM map according to an embodiment of the present invention.

FIG. 3 is a flowchart illustrating operation of start-up processing according to an embodiment of the present invention.

FIG. 4 is a figure illustrating an execution order of start-up processing according to an embodiment, of the present invention.

FIG. 5 is a figure illustrating an overview of a conventional ROM map.

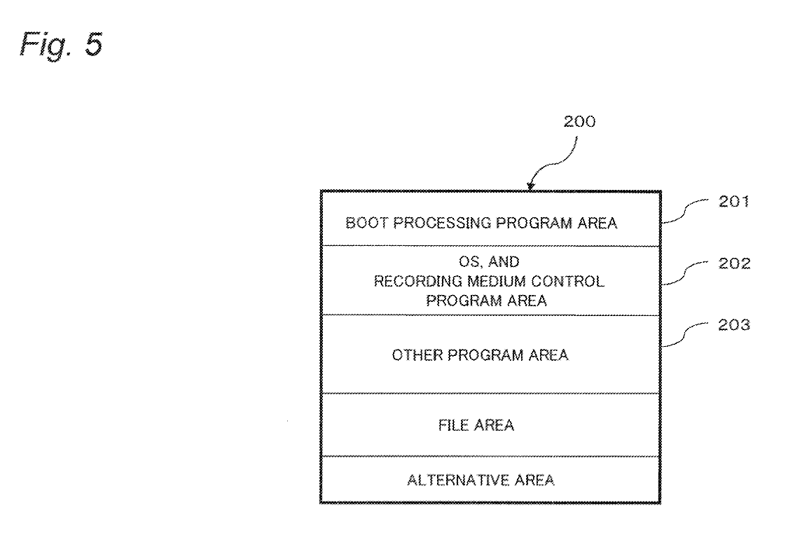

### EMBODIMENT FOR CARRYING OUT THE INVENTION

An embodiment of a recording device according to the present invention will be explained in detail with reference to the drawings.

### 1. Configuration

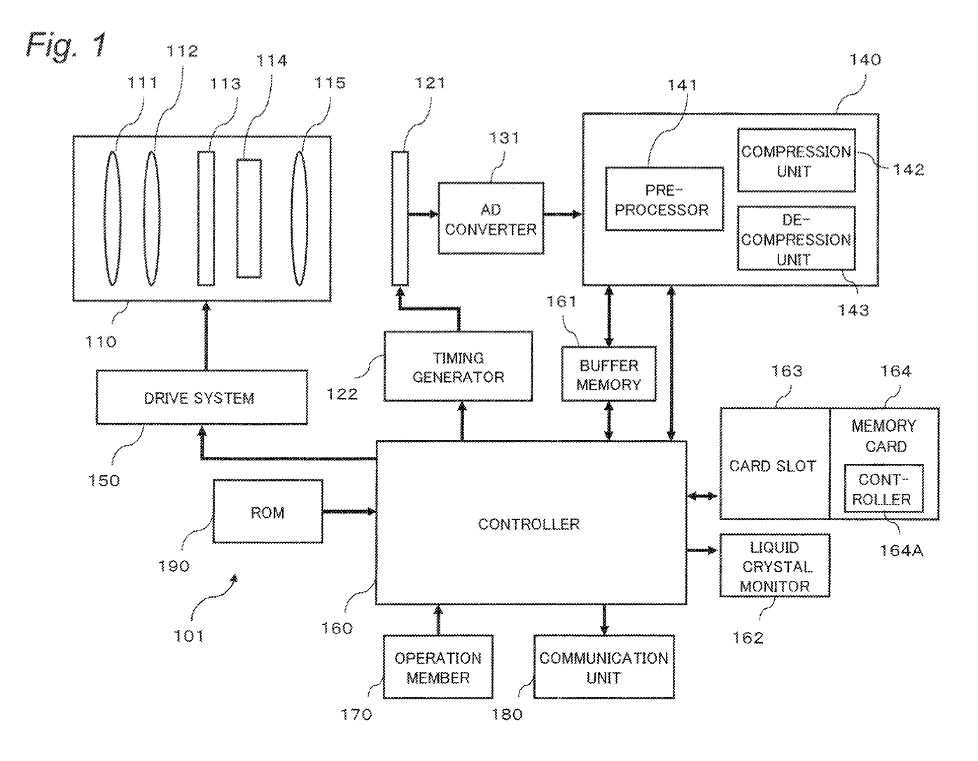

FIG. 1 is a block diagram, illustrating a configuration of a video camera 101 to which the recording device of the present, invention is applied. The video camera 101 includes an optical system 110, an imaging device 121, an image processor 140, a controller 160, a liquid crystal display monitor 162, a memory card 164, and the like. The video camera 101 causes the imaging device 121 to capture a subject image formed by the optical system 110. Image data generated by. the imaging device 121 is subjected to various kinds of processings by the image processor 140, and the processed image data are stored to the memory card 164. The image data stored in the memory card 164 can be displayed on a liquid crystal display monitor 162. The configuration of the video camera 101 will be hereinafter explained in detail.

The optical system 110 includes an objective lens 111, a zoom lens 112, a diaphragm 113, an OIS unit 114, and a focus lens 115. The optical system 110 forms a subject image by collecting lights incident from a subject.

The objective lens 111 is a lens arranged at a position closest to the subject. The zoom lens 112 moves along the optical axis of the optical system 110 to enlarge or reduce the subject image. The diaphragm 113 regulates the amount of light passing through the optical system 110 by adjusting the size of an aperture in accordance with a setting by a user or automatically. The CIS unit 114 has a correction lens that can move within a plane perpendicular to the optical axis. The OIS unit 114 reduces shake in the subject image by driving the correction lens in a direction for canceling the shake of the video camera 101. The focus lens 115 moves along the optical axis of the optical, system 110 to adjust the focal position of the subject image.

A drive system 150 drives these optical elements in the optical system 110.

The imaging device 121 captures the subject image formed by the optical system 110, to generate image data. The imaging device 121 is constituted by a CCD image sensor or a CMOS image sensor.

The video camera 101 further includes a timing generator 122, a communication unit 180, a ROM 190, a buffer memory 161, a card slot 163, and an operation member 170.

The timing generator 122 generates a timing signal for driving the imaging device 121. The imaging device 121 performs various kinds of operations such as exposure, transfer, electronic shutter in accordance with the riming signal generated by the timing generator 122. The AD converter 131 converts the image data generated by the imaging device 121 into a digital signal.

The image processor 140 includes a preprocessor 141, a compression unit 142, and a decompression unit 143. The image processor 140 performs various kinds of processings on the image data. For example, the image processor 140 performs a predetermined processing on image data received from the imaging device 121 via the AD converter 131, thus generating image data to be recorded to the memory card 164 and generating image data to be displayed on the liquid crystal display monitor 162. Further, the image processor 140 performs a predetermined processing or. image data stored in the memory card 164, thus generating image data to be displayed on the liquid crystal display monitor 162, generating image data to be stored back to the memory card 164, and generating image data to be transmitted to an external device via the communication unit 180. The image processor 140 can be achieved with a DSP, a microcomputer, or the like.

The preprocessor 141 performs various kinds of image processings such as gamma correction, white balance correction, and defect correction on the image data converted by the AD converter 131.

The compression unit 142 compresses image data by performing DCT (discrete cosine transform), Huffman coding, or the like. The compression unit 142 compresses the image data using compression formats based on standards such as MPEG-2 or H.264. It should be noted that the compression unit 142 may compress the image data with compression methods other than MPEG-2 or H.264.

In a case where compressed image data stored in the memory card 164 are reproduced on the liquid crystal display monitor 162, the decompression unit 143 decodes the image data back to uncompressed state.

The controller 160 controls the entire video camera 101 based on instructions given by various kinds of programs.

The ROM 190 stores various kinds of programs and data executed by the controller 160. The ROM 190 can be achieved with a nonvolatile memory such as a flash memory.

The buffer memory 161 functions as a work memory for the image processor 140 and the controller 160. The buffer memory 161 is constituted by a volatile memory such as a DRAM, a ferroelectric memory, and the like. The buffer memory 161 can operate at a speed higher than the ROM 190. In order to improve the processing speed, the programs stored in the slow ROM 190 are executed upon being Loaded to the buffer memory 161 that can be accessed at a fast speed.

The card slot 163 is capable of attaching the memory card 164 detachably. The card slot 163 is configured to be mechanically and electrically connectable to the memory card 164.

The memory card 164 includes a flash memory, a ferroelectric memory, or the like, and stores data. The memory card 164 has a memory controller 164A for controlling the entire memory card 164. For example, when the. memory controller 164A receives an initialization command from the controller 160 of the main body, the memory controller 164A executes initialization processing of the memory card 164. The time needed to perform the initialization processing of the memory card 164 varies according to the capacity and the manufacturer. In general, the larger the capacity of the memory card 164 is, the longer it takes to perform the initialization processing of the memory card 164. For example, when the capacity of the memory card 164 is several gigabytes, it takes about one second to perform the initialization processing of the memory card 164.

The controller 160 stores generated image data to the memory card 164.

The liquid crystal display monitor 162 can display images generated by the imaging device 121, images read from the memory card 164, and the like. In addition, the liquid crystal display monitor 162 can display various kinds of setting information of the video camera 101, times at which images are taken, and the like.

The operation member 170 is a component which collectively relates to various kinds of operation means. The operation member 170 receives instructions given by users and transmits the received instructions to the controller 160,

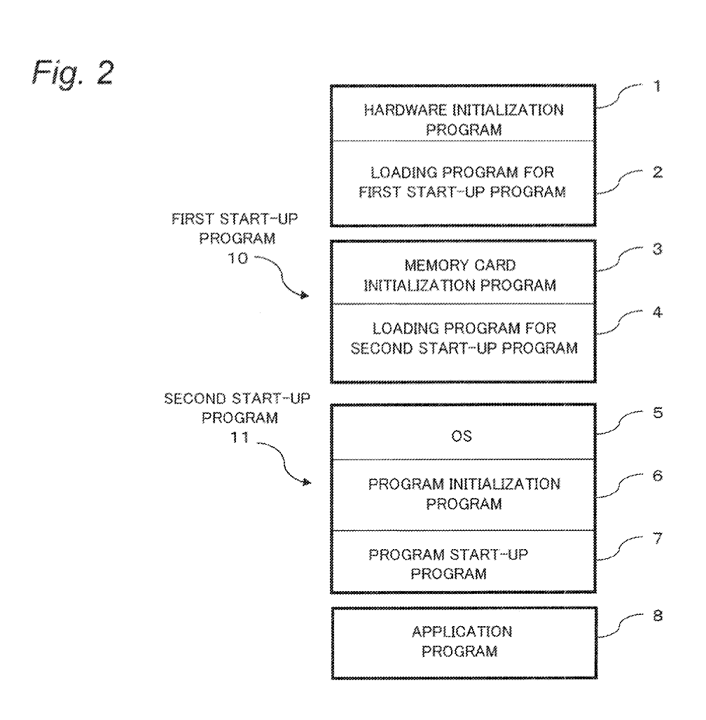

FIG. 2 illustrates various kinds of programs stored in the ROM 190. The ROM 190 stores a plurality of programs. More specifically, the ROM 190 stores a hardware initialization program 1 for performing initialization processing of each of plural pieces of hardware composing the video camera 101, a loading program 2 for loading a first start-up program 10, the first start-up program 10, a second start-up program 11, and an application program 8 (hereinafter referred to as “appli-program 8”).

The first start-up program 10 is constituted by a memory card initialization program 3 for issuing an initialization command to the memory card 164 and a loading program 4 for loading the second start-up program 11.

The second start-up program 11 includes an OS (operating system) 5, a program initialization program 6 for performing initialization processing of various kinds of programs running on the OS 5, and a program start-up program 7 for performing start-up processing of these various kinds of programs. It should be noted that the various kinds of programs include not only the appli-program 8 but also middleware, drivers, and the like.

The appli-program 8 is a program for achieving various kinds of functions of the video camera 101 such as shooting and editing.

As described above, the first start-up program 10 is constituted only by the memory card initialization program 3 for issuing the initialization command and the loading program 4 for loading the second start-up program 11, and accordingly, the first start-up program 10 has only a few instructions. Therefore, the file size of the first start-up program 10 is much smaller then the second start-up program 11 including the OS 5 and the application program 8. As a result, the first start-up program 10 can be loaded from the ROM 190 to the buffer memory 161 in a much shorter time than the second start-up program 11.

### 2. Operation

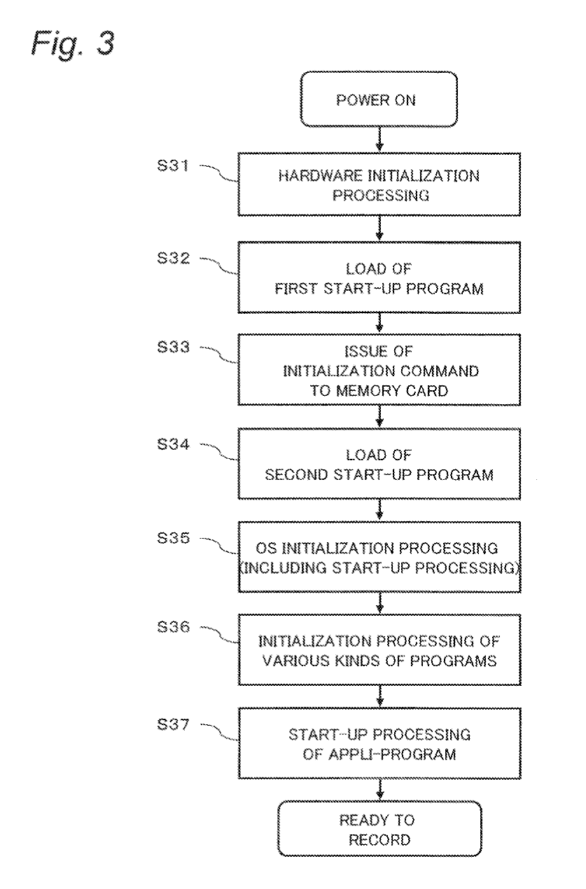

The start-up operation of the video camera 101 having the above configuration will be hereinafter explained with reference to a flowchart shown in FIG. 3.

When the video camera 101 is powered on, the controller 160 reads the hardware initialization program 1 from the ROM 190, and initializes a card interface controller (not shown) based on the instruction (step S31). The card interface controller is hardware for issuing the initialization command for initializing the memory card 164. The card interface controller may be arranged in the card slot 163, or may be arranged in the controller 160.

When the initialization of the card interface controller is completed, the controller 160 reads the loading program 2 for the first start-up program from the ROM 190, and loads the first start-up program 10 stored in the ROM 190 to the buffer memory 161 based on the instruction in the loading program 2 (step S32).

When the loading is completed, the controller 160 executes the first start-up program 10 loaded to the buffer memory 161. More specifically, the controller 160 issues an initialization command to the controller 164A of the memory card 164 by way of the card slot 163 based on the instruction of the memory card initialization program 3 (step S33). When the controller 164A of the memory card 164 receives the initialization command, the controller 164A of the memory card 164 executes the initialization processing of the memory card 164.

After the controller 160 issues the initialization command of the memory card 164, the controller 160 loads the second start-up program 11 stored in the ROM 190 to the buffer memory 161 based on the instruction of the loading program 4 for the second start-up program (step S34). At this occasion, the second start-up program 11 is loaded in parallel with the initialization processing executed in the memory card 164.

When the leading is completed, the controller 160 executes the second start-up program 11 loaded to the buffer memory 161. The controller 160 performs an initialization processing of the OS 5 (including the start-up processing of the OS 5) (step S35). Afterwards, the controller 160 executes initialization processings of various kinds of programs running on the OS 5 (step S36). After the initialization processing is completed, the controller 160 executes start-up processings of various kinds of appli-programs 8 (step S37). When the start-up processings of the various kinds of appli-programs 8 are completed, the start-up of the entire video camera 101 is completed, and the video camera 101 is now ready to record, a video.

As described above, according to the present embodiment, the first start-up program 10 is constituted by the initialization program 3 for the memory card 164 and the loading program 4 for the second start-up program. Therefore, the initialization processing of the memory card 164 as well as the loading processing of the second start-up program 11 can be executed in parallel.

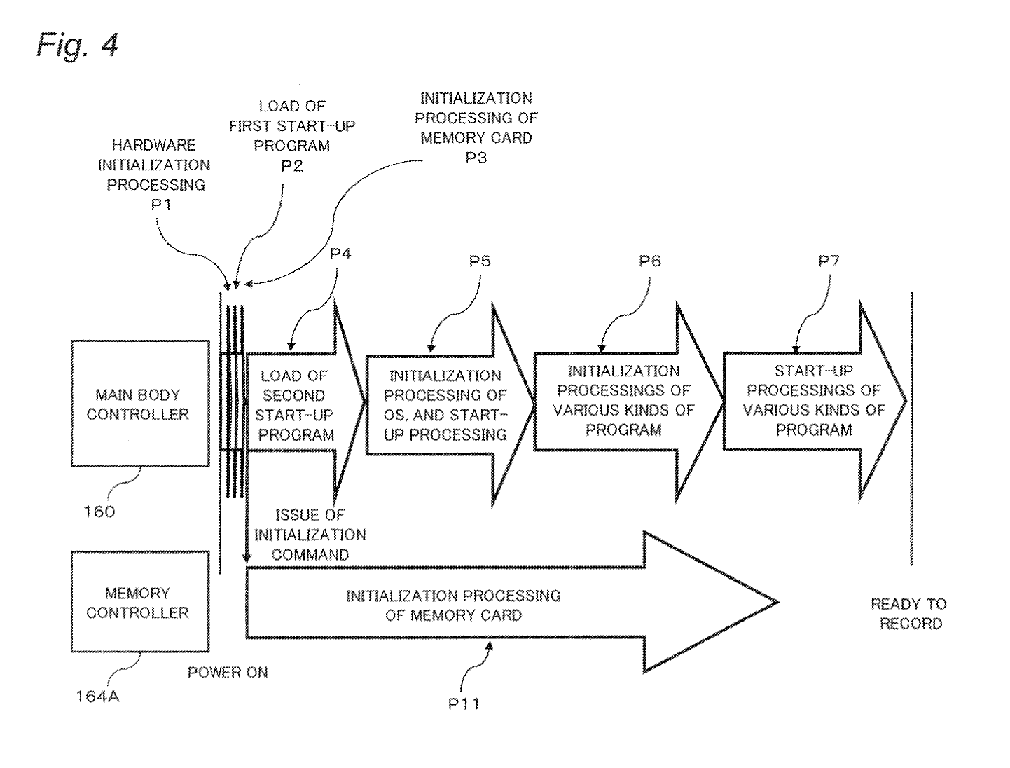

FIG. 4 uses arrows to illustrate several processings which are performed from when the video camera 101 is powered on to when the video camera 101 becomes ready to record a video, i.e., an execution order of the processings during start-up. The length of each of arrows approximately represents the time needed for the corresponding processing. Immediately after the hardware initialization processing (P1) and the loading of the first start-up program 10 (P2), the controller 160 of the main body executes the memory card initialization program 3 in the first start-up program 10 (P3), and issues the initialization command to the memory card 164. When the memory controller 164A of the memory card 164 receives the initialization command, the memory controller 164A of the memory card 164 executes the initialization processing of the memory card 164 (P11).

On the other hand, after the controller 160 of the main body issues the initialization command, the controller 160 of the main body executes the loading program 4 for the second start-up program in the first start-up program 10 to load the second start-up program II. After the controller 160 loads the second start-up program 11, the controller 160 executes the program 11 (P4). More specifically, the controller 160 successively executes the initialization processing of the OS 5 (P5), the initialization processings of the various kinds of programs performed by the program initialization program 6 (P6), and the start-up processings of the various kinds of programs performed by the program start-up program 7 (P7). As described above, according to the present embodiment, after the initialization command of the memory card 164 is issued, the initialization processing of the memory card 164 performed by the memory controller 164A (P11) and the post-loading processings of the second start-up program 11 performed by the controller 160 of the. main body (P5, P6, P7) are executed in parallel. Therefore, the start-up time, i.e., the time from when the video camera 101 is powered on to when the video camera 101 becomes ready to record a video, can be greatly reduced.

In the example of FIG. 4, the initialization processing of the memory card 164 is completed before the start-up processings of the various kinds of programs. However, in a case where the capacity of the memory card 164 is large, the initialization processing of the memory card 164 may be completed after the start-up processings of the various kinds of programs. Even in such case, the video camera 101 according to the present embodiment becomes ready to record a video in a shorter time than the conventional device.

In Patent Document 1, after the device is powered on but before the device loads the OS, the device accesses a boot program, afterwards starts loading the OS. In the present embodiment, the device performs the hardware initialization processing to load the first start-up program 10, afterwards starts loading the OS 5. However, the access to the boot program in Patent Document 1 and the hardware initialization processing and the loading of the first start-up program 10 in the present embodiment are both completed in a very short time. Therefore, a difference of these processing times can almost be disregarded. The reason why the first start-up program. 10 is loaded in a very short time is because the first start-up program 10 has only a few instructions as described above.

### 3. Summary

In the video camera 101 according to the present, embodiment, the controller 160 executes the memory card initialization program 3 before the second start-up program 4 including the OS 5 arid the like is loaded to the buffer memory 161 when the video camera 101 according to the present embodiment is powered on. Therefore, the initialization processing of the memory card 164 is started without waiting for the completion, of the initialization processing of the OS 5 which takes a lot of time to be completed. In other words, the initialization processing of the memory card 164 is performed in parallel with the loading and the initialization processing of the OS 5. Therefore, the initialization processing of the memory card 164, which is likely to take a longer processing time when the capacity of the memory card 164 is large, can be completed in a shorter time compared with a case where the initialization processing of the memory card 164 is executed after the loading and the initialization processing of the OS 5 are completed. In other words, the time from when the video camera 101 is powered on to when the video camera 101 becomes ready to record a video can be reduced.

In the present embodiment, when the video camera 101 is powered on, the controller 160 of the video camera 101 executes the memory card initialization program 3 and transmits, the initialization command to the memory card 164, afterwards starts loading the OS 5 to the buffer memory 161. Therefore, the time from when the video camera 101 is powered on to when the video camera 101 becomes ready to record a video can be further reduced.

The particular embodiment of the present invention has been hereinabove explained. However, it is apparent that a person skilled in the art would be able to make many other modifications, corrections, and other uses. Therefore, the present invention is not limited to this particular disclose, and the present invention can be limited only by the attached claims. The present application is related to JP-A-2008-152598 (filed on Jun. 11, 2008), and the contents thereof are incorporated herein by reference.

### INDUSTRIAL APPLICABILITY

In a recording device for recording an image and the like to a recording medium, a time from when the recording device is powered on to when the recording device becomes ready to record a video can be reduced according to the present invention. The present invention is useful for image capturing devices such as a digital still camera and a digital video camera.

### DESCRIPTION OF SYMBOLS

1 hardware initialization program;

3 memory card initialization program

5 OS

10 first start-up program

11 second start-up program

101 video camera

110 optical system

140 image processor

160 controller

161 buffer memory

163 card slot

164 memory card

164A controller

170 operation member

190 ROM

1. A recording device capable of recording data to a recording medium that executes initialization operation when the recording medium receives an initialization command, the recording device comprising:
a controller operable to control operation of the recording device; and
a storage unit operable to store an operating system which is executed by the controller after a start-up of the recording device is completed, and provides a predetermined function,
wherein the controller performs start-up control so that the controller provides an instruction for initializing the recording medium when the recording device is powered on, and in parallel with the initialization of the recording medium, the controller executes initialization of the operating system.

2. The recording device according to claim 1 further comprising a second storage unit providing a work area for the operating system,
wherein the controller performs start-up control so that, when the recording device is powered on, the controller transmits the initialization command to the recording medium, and afterwards, loads the operating system to the second storage unit from the storage unit storing the operating system.

3. The recording device according to claim 1, wherein the recording medium is a recording medium detachably connected to the recording device.

4. A method for activating a recording device capable of recording data to a recording medium that executes initialization operation when the recording medium receives an initialization command, the method comprising:
when the recording device is powered on, initializing, by the recording device, an operating system which provides a predetermined function in the recording device when a start-up of the recording device is completed, in parallel with initialization of the recording medium.

5. The method for activating the recording device according to claim 4, further comprising, when the recording device is powered on, transmitting the initialization command to the recording medium, and afterwards, loading the operating system.
